(19) United States
(12) Patent Application Publication
(10) Pub. No.: US 2025/0118475 A1
(43) Pub. Date: Apr. 10, 2025

(54) INTEGRATED MAGNETIC ELEMENT

(71) Applicant: LITE-ON Technology Corporation, Taipei City (TW)

(72) Inventors: Chen CHEN, Taipei City (TW); Chi-Yuan FENG, Taipei City (TW); De-Jia LU, Taipei City (TW)

(21) Appl. No.: 18/792,599

(22) Filed: Aug. 2, 2024

Related U.S. Application Data
(60) Provisional application No. 63/588,303, filed on Oct. 6, 2023.

(30) Foreign Application Priority Data
May 10, 2024 (TW) 113117455

(51) Int. Cl. H01F 27/00; H01F 27/28

(52) U.S. Cl. CPC H01F 27/006; H01F 27/2823; H01F 27/2847

(57) ABSTRACT

Disclosed is an integrated magnetic element including a magnetic core structure, a transformer coil group and an excitation coil. The magnetic core structure includes a magnetic frame, at least one transformer magnetic column and at least one induction magnetic column, the transformer magnetic column connects a first side wall and a second side wall of the magnetic frame opposite to each other, there is no air gap between the first side wall and the transformer magnetic column and between the second side wall and the transformer magnetic column, the induction magnetic column is connected to the first side wall, and there is an air gap between the induction magnetic column and the second side wall. The transformer coil group is wound around the transformer magnetic column. The excitation coil is wound around the induction magnetic column and is connected in parallel with a primary-side coil of the transformer coil group.

### CROSS REFERENCE TO RELATED PRESENT DISCLOSURE

This application claims the priority benefit of U.S. Provisional Application Ser. No. 63/588,303, filed on Oct. 6, 2023, and Taiwan Patent Application Serial Number 113117455, filed on May 10, 2024, and the full disclosures of which are incorporated herein by reference.

### TECHNICAL FIELD

The present disclosure relates to a magnetic element, and in particular to an integrated magnetic element that can be used in an LLC resonant converter to achieve zero-voltage switching while reducing the volume to increase space utilization.

### RELATED ART

LLC resonant converters are often used in server power supplies or consumer electronics. Since the voltage at an output terminal of the LLC resonant converter is much lower than that at an input terminal of the LLC resonant converter, the current at the output terminal of the LLC resonant converter is much greater than that at the input terminal of the LLC resonant converter. Therefore, the conversion efficiency of LLC resonant converter is often related to the current.

The LLC resonant converter requires the current of the excitation inductor to achieve zero-voltage switching to reduce the switching loss of the switch. The conventional implementation method is to install an additional excitation inductor outside the structure of a transformer. However, this method makes the volume of the magnetic element composed of the transformer and the excitation inductor larger, thereby affecting the space utilization of the electronic device using the magnetic element.

Therefore, how to provide an integrated magnetic element that can achieve zero-voltage switching when used in an LLC resonant converter while reducing the volume to increase space utilization is an urgent development for those skilled in the art.

### SUMMARY

Embodiments of the present disclosure provide an integrated magnetic element whose structural design can achieve zero-voltage switching when used in an LLC resonant converter, while reducing the volume to increase space utilization.

The present disclosure provides an integrated magnetic element, which includes a magnetic core structure, a transformer coil group and an excitation coil. The magnetic core structure includes a magnetic frame, at least one transformer magnetic column and at least one induction magnetic column. The at least one transformer magnetic column is disposed in the magnetic frame and connected to a first side wall and a second side wall of the magnetic frame opposite to each other, and there is no air gap between the first side wall and the at least one transformer magnetic column and between the second side wall and the at least one transformer magnetic column. The at least one induction magnetic column is connected to the first side wall, and there is an air gap between the at least one induction magnetic column and the second side wall. The transformer coil group is wound around the at least one transformer magnetic column, and includes a primary-side coil and a secondary-side coil group. The excitation coil is wound around the at least one induction magnetic column, and the excitation coil is connected in parallel with the primary-side coil.

The present disclosure provides another integrated magnetic element, which includes a magnetic core structure, a transformer coil group and an excitation coil. The magnetic core structure includes a magnetic frame, a transformer magnetic column, a cover plate, two supporting columns and an induction magnetic column. The transformer magnetic column is disposed in the magnetic frame and connected to opposite side walls of the magnetic frame, and there is no air gap between the opposite side walls and the transformer magnetic column. The two supporting columns are configured to connect any side wall of the magnetic frame and the cover plate, and disposed on opposite sides of the cover plate. The induction magnetic column is disposed in an accommodation space formed by the any side wall, the cover plate and the two supporting columns. There is an air gap between the induction magnetic column and the any side wall, between the induction magnetic column and at least one of the two supporting columns, or between the induction magnetic column and the cover plate, or the induction magnetic column has the air gap. The transformer coil group is wound around the transformer magnetic column and includes a primary-side coil and a secondary-side coil group. The excitation coil is wound around the induction magnetic column, and the excitation coil is connected in parallel with the primary-side coil.

The present disclosure further provides another integrated magnetic element, which includes a magnetic frame, a first magnetic column, a second magnetic column, a first winding and a second winding. The magnetic frame forms an accommodation space. The first magnetic column and the second magnetic column are disposed in the accommodation space. The first magnetic column has an air gap. The first winding is wound around the first magnetic column. The second winding is wound around the second magnetic column. An axis extension direction of the first magnetic column is the same as an axis extension direction of the second magnetic column, or the axis extension direction of the first magnetic column is perpendicular to the axis extension direction of the second magnetic column.

In the integrated magnetic elements of the embodiments of the present disclosure, by integrating the magnetic core structure of the transformer with the magnetic core structure of the excitation inductor (that is, the transformer magnetic column and the induction magnetic column being disposed in the magnetic frame; or the transformer magnetic column being disposed in the magnetic frame, and the induction magnetic column being disposed in the accommodation space formed by one side wall of the magnetic frame, the cover plate and the two supporting columns; or the second magnetic column and the first magnetic column being disposed in the magnetic frame), zero-voltage switching can be achieved when the integrated magnetic element is used in the LLC resonant converter, while reducing the volume to increase space utilization.

### BRIEF DESCRIPTION OF THE DRAWINGS

Accompanying drawings described herein are intended to provide a further understanding of the present disclosure and form a part of the present disclosure, and exemplary embodiments of the present disclosure and descriptions thereof are intended to explain the present disclosure but are not intended to unduly limit the present disclosure. In the drawings:

FIG. 1 is a perspective view of an integrated magnetic element according to a first embodiment of the present disclosure;

FIG. 2 is a side view of the integrated magnetic element of FIG. 1;

FIG. 3 is a current waveform diagram of secondary-side rectifier switches of the integrated magnetic element of FIG. 1;

FIG. 4 is a schematic diagram of a winding stack of a prior common transformer;

FIG. 5 is a current waveform diagram of secondary-side rectifier switches of the transformer of FIG. 4;

FIG. 6 is a perspective view of an integrated magnetic element according to a second embodiment of the present disclosure;

FIG. 7 is a side view of the integrated magnetic element of FIG. 6;

FIG. 8 is a perspective view of an integrated magnetic element according to a third embodiment of the present disclosure;

FIG. 9 is a side view of the integrated magnetic element of FIG. 8;

FIG. 10 is a perspective view of an integrated magnetic element according to a fourth embodiment of the present disclosure;

FIG. 11 is a side view of the integrated magnetic element of FIG. 10;

FIG. 12 is a side view of a magnetic core structure according to an embodiment of the present disclosure;

FIG. 13 is a perspective view of an integrated magnetic element according to a fifth embodiment of the present disclosure;

FIG. 14 is a side view of the integrated magnetic element of FIG. 13;

FIG. 15 is a perspective view of an integrated magnetic element according to a sixth embodiment of the present disclosure;

FIG. 16 is a side view of the integrated magnetic element of FIG. 15;

FIG. 17 is a perspective view of an integrated magnetic element according to a seventh embodiment of the present disclosure;

FIG. 18 is a side view of the integrated magnetic element of FIG. 17;

FIG. 19 is a perspective view of an integrated magnetic element according to an eighth embodiment of the present disclosure;

FIG. 20 is a side view of the integrated magnetic element of FIG. 19;

FIG. 21 is a perspective view of an integrated magnetic element according to a ninth embodiment of the present disclosure;

FIG. 22 is a side view of the integrated magnetic element of FIG. 21;

FIG. 23 is a perspective view of an integrated magnetic element according to a tenth embodiment of the present disclosure; and

FIG. 24 is a side view of the integrated magnetic element of FIG. 23.

### DETAILED DESCRIPTION OF THE EMBODIMENTS

The embodiments of the present disclosure will be described below in conjunction with the relevant drawings. In the figures, the same reference numbers refer to the same or similar components or method flows.

It must be understood that the words “including”, “comprising” and the like used in this specification are used to indicate the existence of specific technical features, values, method steps, work processes, elements and/or components. However, it does not exclude that more technical features, values, method steps, work processes, elements, components, or any combination of the above can be added.

It must be understood that when an element is described as being “connected” or “coupled” to another element, it may be directly connected or coupled to another element, and intermediate elements therebetween may be present. In contrast, when an element is described as “directly connected” or “directly coupled” to another element, there is no intervening element therebetween.

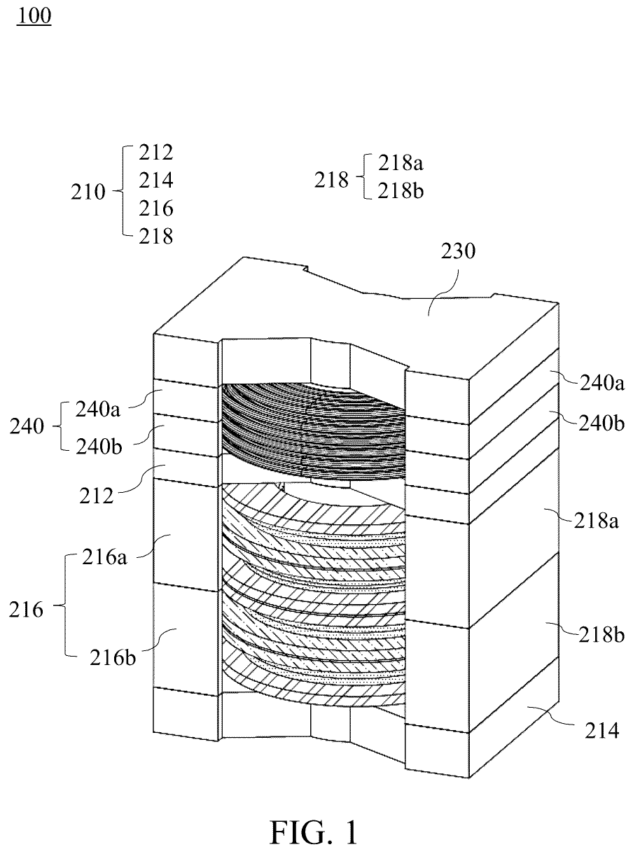

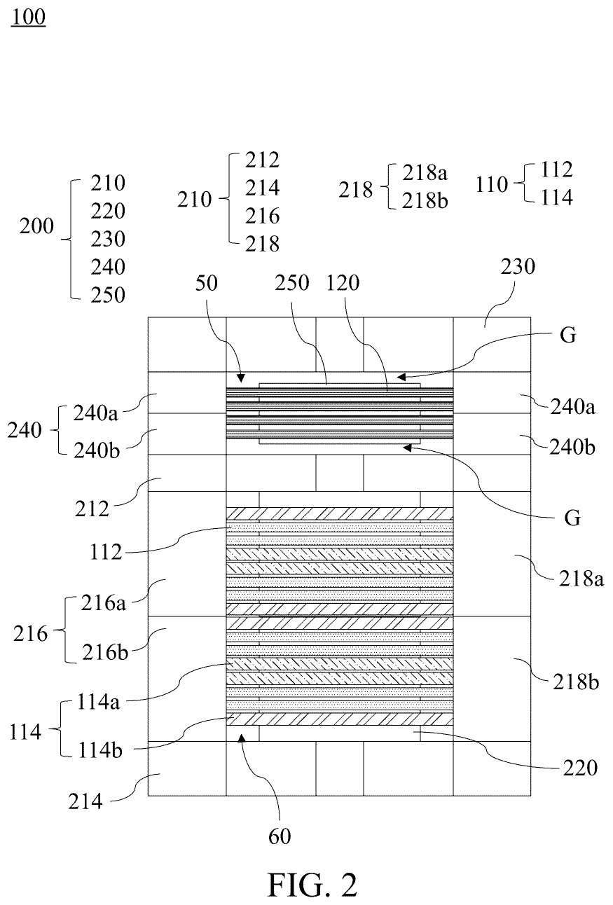

Please refer to FIG. 1 and FIG. 2. FIG. 1 is a perspective view of an integrated magnetic element according to a first embodiment of the present disclosure, and FIG. 2 is a side view of the integrated magnetic element of FIG. 1. As shown in FIG. 1 and FIG. 2, an integrated magnetic element 100 comprises a magnetic core structure 200, a transformer coil group 110 and an excitation coil 120. The magnetic core structure 200 comprises a magnetic frame 210, a transformer magnetic column 220, a cover plate 230, two supporting columns 240 and an induction magnetic column 250. The transformer magnetic column 220 is disposed in the magnetic frame 210 and connected to a first side wall 212 and a second side wall 214 of the magnetic frame 210 opposite to each other (i.e., the opposite side walls of the magnetic frame 210). There is no air gap between the transformer magnetic column 220 and the first side wall 212. There is no air gap between the transformer magnetic column 220 and the second side wall 214. The transformer magnetic column 220 has no air gap. The two supporting columns 240 connect the first side wall 212 of the magnetic frame 210 (i.e., one side wall of the magnetic frame 210) and the cover plate 230, and the two supporting columns 240 are disposed on opposite sides of the cover plate 230. The induction magnetic column 250 is disposed in an accommodation space 50 formed by the first side wall 212, the cover plate 230 and the two supporting columns 240. There is an air gap G between the induction magnetic column 250 and the first side wall 212, between the induction magnetic column 250 and at least one of the two supporting columns 240, or between the induction magnetic column 250 and the cover plate 230.

In this embodiment, the magnetic frame 210 may comprise the first side wall 212, the second side wall 214, a third side wall 216 and a fourth side wall 218. The first side wall 212, the second side wall 214, the third side wall 216 and the fourth side wall 218 form a receiving space 60, the first side wall 212 and the second side wall 214 are arranged opposite to each other, and the third side wall 216 and the fourth sidewall 218 are arranged opposite to each other. The third side wall 216 may be formed by stacking a first supporting column 216a and a first supporting column 216b, and the fourth side wall 218 may be formed by stacking a second supporting column 218a and a second supporting column 218b. The support column 240 may be formed by stacking a magnetic column 240a and a magnetic column 240b. The materials of the magnetic frame 210, the transformer magnetic column 220, the cover plate 230, the supporting column 240 and the induction magnetic column 250 may be an iron powder core with low magnetic permeability, such as Fe—Si based alloy and Fe—Ni based alloy, or a ferrite core with high magnetic permeability. The central axis of the induction magnetic column 250 is parallel to the central axis of the transformer magnetic column 220. There may be an air gap G between the induction magnetic column 250 and the first side wall 212, and there may be an air gap G between the induction magnetic column 250 and the cover plate 230. However, this embodiment is not intended to limit the present disclosure.

The transformer coil group 110 is wound around the transformer magnetic column 220 and comprises a primary-side coil 112 and a secondary-side coil group 114. The excitation coil 120 is wound around the induction magnetic column 250, and the excitation coil 120 is connected in parallel with the primary-side coil 112.

By disposing the transformer magnetic column 220 and the induction magnetic column 250 in the magnetic frame 210, the magnetic core structure of the transformer and the magnetic core structure of the excitation inductor are integrated to achieve zero-voltage switching when the integrated magnetic element 100 is used in an LLC resonant converter, while reducing the volume to increase space utilization. In addition, the excitation inductor composed of the induction magnetic column 250 and the excitation coil 120 has an air gap G, the transformer composed of the transformer magnetic column 220 and the transformer coil group 110 has no air gap, and the excitation coil 120 is connected in parallel with the primary-side coil 112, so that when the integrated magnetic element 100 is used in an LLC resonant converter, the copper loss of the transformer is reduced, and the drastic impact of the air gap G on the performance of the secondary-side coil group 114 is reduced.

In addition, when a winding direction of the excitation coil 120 is the same as a winding direction of the transformer coil group 110 in FIG. 2, magnetic flux cancellation can be achieved, thereby reducing iron loss, wherein the primary-side coil 112 and the secondary-side coil group 114 of the transformer coil group 110 are wound in the same direction.

In one embodiment, the secondary-side coil group 114 may comprise a first secondary-side coil 114a and a second secondary-side coil 114b, and the transformer coil group 110 may be wound around the transformer magnetic column 220 in such a periodic manner that the primary-side coil 112 is wound between the first secondary-side coil 114a and the second secondary-side coil 114b. The first secondary-side coil 114a may be a positive half-cycle winding, and the second secondary-side coil 114b may be a negative half-cycle winding.

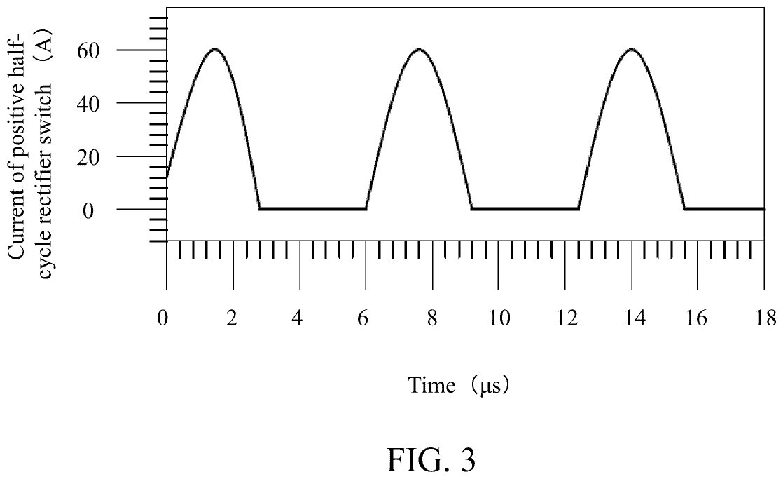

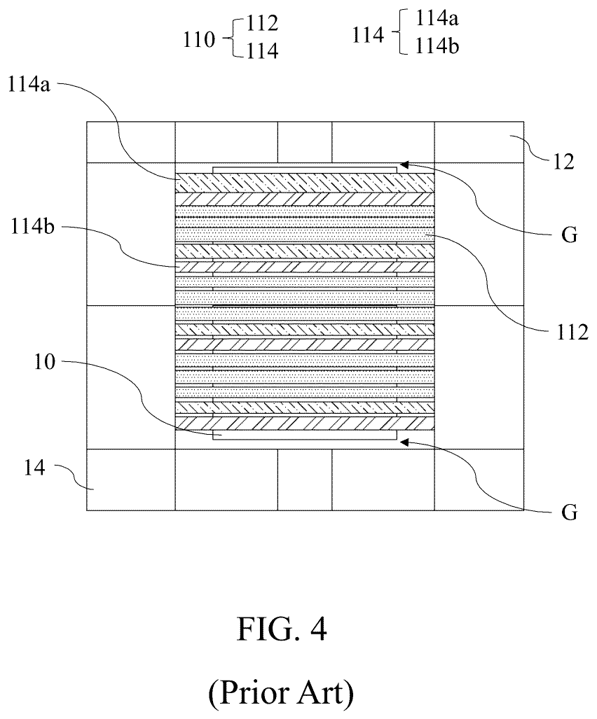

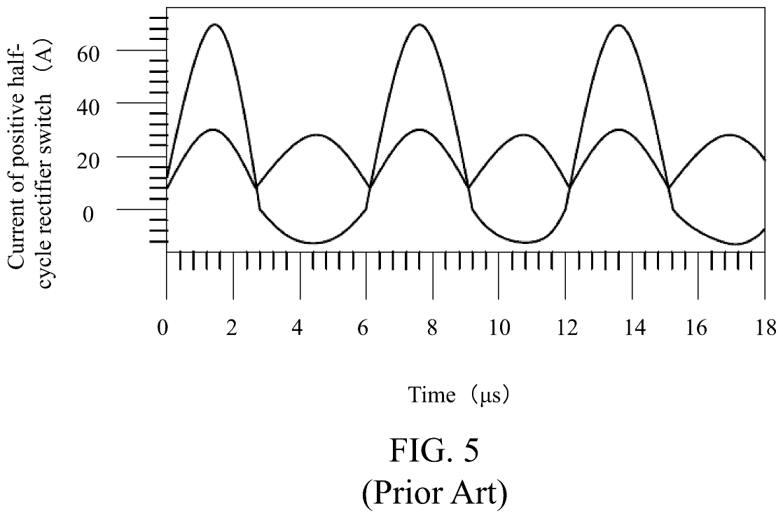

Please refer to FIG. 2 to FIG. 5, wherein FIG. 3 is a current waveform diagram of secondary-side rectifier switches of the integrated magnetic element of FIG. 1, FIG. 4 is a schematic diagram of a winding stack of a prior common transformer, and FIG. 5 is a current waveform diagram of secondary-side rectifier switches of the transformer of FIG. 4. In FIG. 3 and FIG. 5, the horizontal axis indicates time in microseconds (μs), and the vertical axis indicates current of positive half-cycle rectifier switch in amperes (A). In the transformer of FIG. 4, there are air gaps G between the transformer magnetic column 10 and cover plates 12 and 14 adjacent thereto, and the transformer coil group 110 is wound around the transformer magnetic column 10 in such a periodic manner that the second secondary-side coil 114b is wound between the first secondary-side coil 114a and the primary-side coil 112. In the integrated magnetic element 100 of FIG. 1 and the transformer of FIG. 4, the turn ratio of the primary-side coil 112, the first secondary-side coil 114a and the second secondary-side coil 114b may be 33:1:1. The integrated magnetic element 100 of FIG. 1 and the transformer of FIG. 4 are respectively applied to a 1.8 kW LLC resonant converter with an operating frequency of 160 kilohertz (kHz) to obtain the waveform diagrams of FIG. 3 and FIG. 5.

As shown in FIG. 2 and FIG. 3, based on the arrangement of the transformer coil group 110 wound around the transformer magnetic column 220 in FIG. 2, the integrated magnetic element 100 of FIG. 1 can realize the current sharing of the induced current on the secondary side (that is, there is a more even current distribution for the secondary-side rectifier switches, as shown in FIG. 3; it should be noted that due to the current sharing phenomenon, the current waveforms of multiple secondary-side rectifier switches overlap), to reduce stresses on secondary-side rectifier switches. As shown in FIG. 4 and FIG. 5, based on the arrangement of the transformer coil group 110 wound around the transformer magnetic column 10 in FIG. 4, there is current imbalance in secondary-side rectifier switches of the transformer of FIG. 4 as shown in FIG. 5. It can be seen from FIG. 3 and FIG. 5 that the difference in peak current between FIG. 3 and FIG. 5 can reach 20%, and the integrated magnetic element 100 of FIG. 1 can effectively reduce the conduction loss of the secondary-side rectifier switches.

In addition, when considering the impact of temperature rise on loss caused by the current imbalance in the secondary-side rectifier switches, the loss of the secondary-side rectifier switches of the integrated magnetic element 100 of FIG. 1 is less than that of the secondary-side rectifier switches of the transformer of FIG. 5.

In one embodiment, the primary-side coil 112 may be, but is not limited to, a coil winding and is composed of Litz wire; the secondary-side coil group 114 may be, but is not limited to, a copper sheet winding.

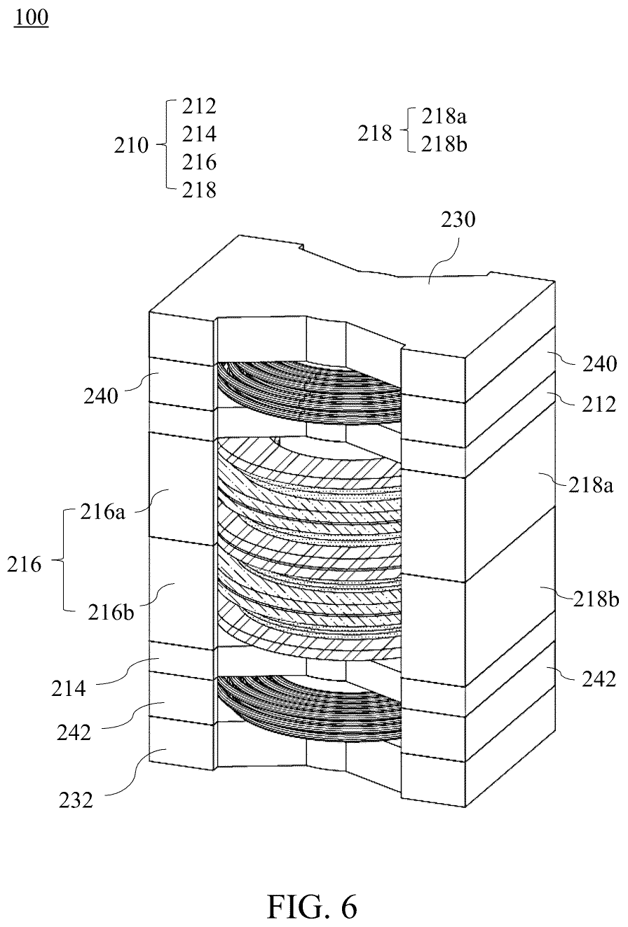

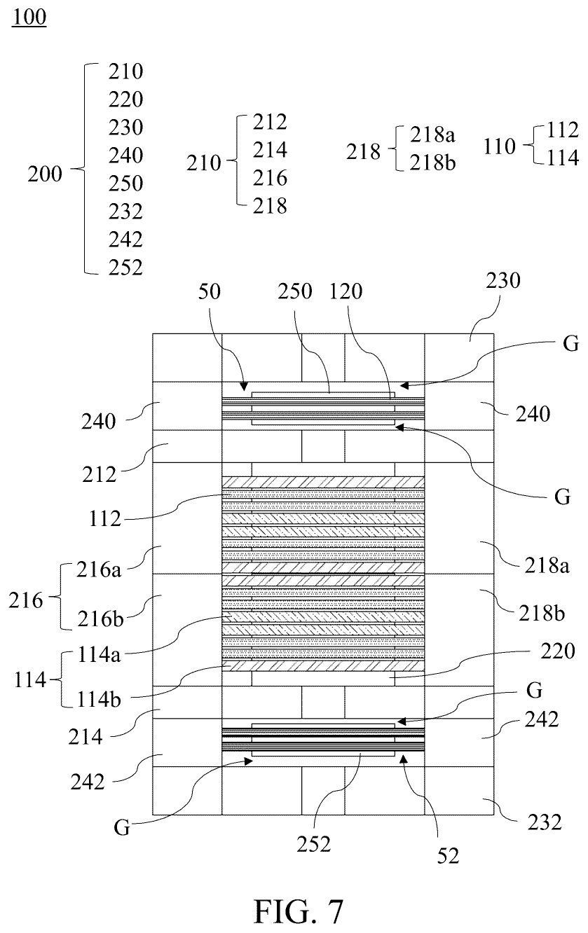

Please refer to FIG. 6 and FIG. 7, wherein FIG. 6 is a perspective view of an integrated magnetic element according to a second embodiment of the present disclosure, and FIG. 7 is a side view of the integrated magnetic element of FIG. 6. As shown in FIG. 6 and FIG. 7, the difference between the second embodiment and the first embodiment is that the magnetic core structure 200 of FIG. 6 and FIG. 7 may further comprise a cover plate 232, an induction magnetic column 252 and two supporting columns 242. The two supporting columns 242 connect the second side wall 214 of the magnetic frame 210 and the cover plate 232, and are disposed on opposite sides of the cover plate 232. The induction magnetic column 252 is disposed in an accommodation space 52 formed by the second side wall 214, the cover plate 232 and the two supporting columns 242, and the central axis of the induction magnetic column 252 is parallel to the central axis of the transformer magnetic column 220. There may be an air gap G between the induction magnetic column 252 and the second side wall 214. There may be an air gap G between the magnetic column 252 and the cover plate 232. The excitation coil 120 is further wound around the induction magnetic column 252. In addition, since the arrangement in which the transformer coil group 110 is wound around the transformer magnetic column 220 in FIG. 7 is the same as the arrangement in which the transformer coil group 110 is wound around the transformer magnetic column 220 in FIG. 2, the integrated magnetic element 100 of the second embodiment can also realize the current sharing of the secondary-side coil group 114 and reduce the stresses on the secondary-side rectifier switches.

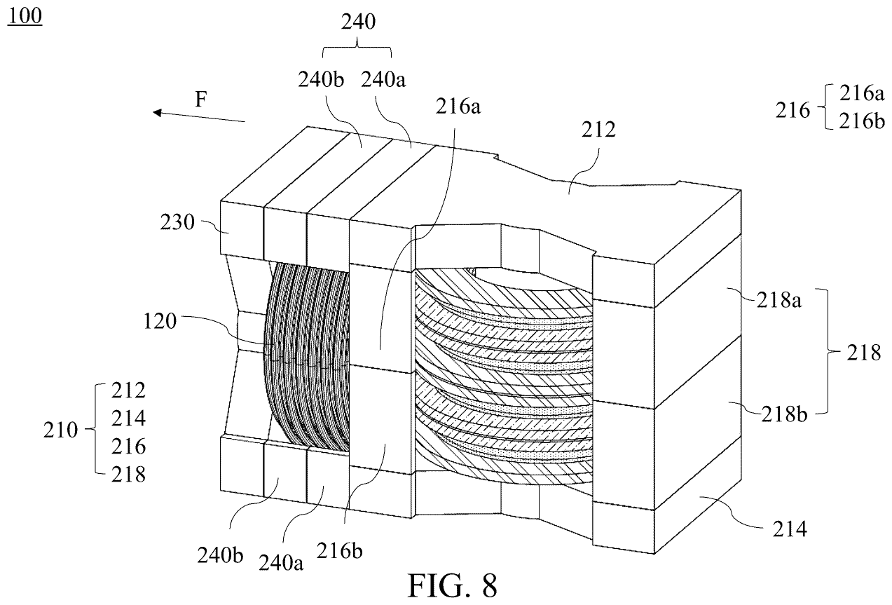

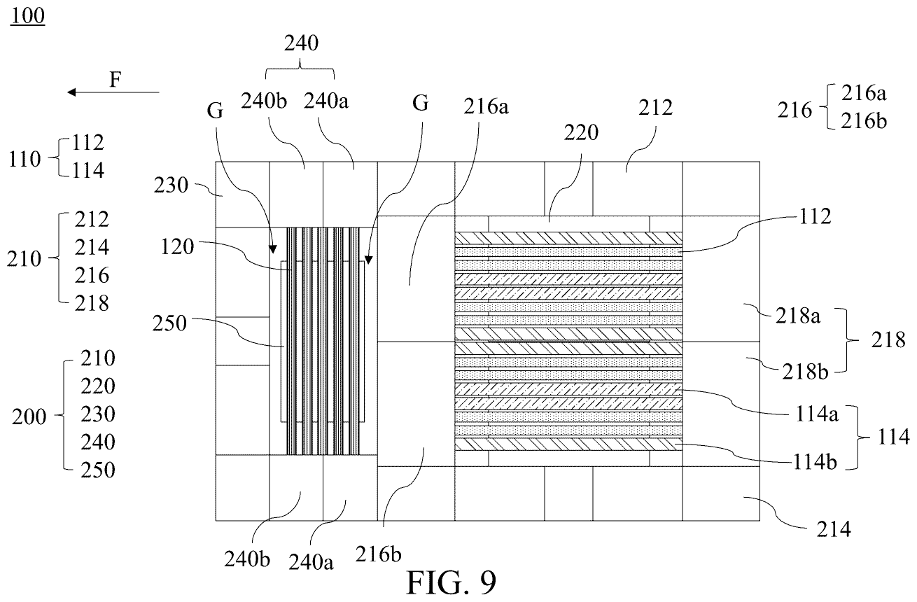

Please refer to FIG. 8 and FIG. 9, wherein FIG. 8 is a perspective view of an integrated magnetic element according to a third embodiment of the present disclosure, and FIG. 9 is a side view of the integrated magnetic element of FIG. 8. As shown in FIG. 8 and FIG. 9, the difference between the third embodiment and the first embodiment is that the two supporting columns 240 of FIG. 8 and FIG. 9 connect the third side wall 216 of the magnetic frame 210 and the cover plate 230. The induction magnetic column 250 is disposed in the accommodation space formed by the third side wall 216, the cover plate 230 and the two supporting columns 240. The central axis of the induction magnetic column 250 is perpendicular to the central axis of the transformer magnetic column 220. There is an air gap G between the induction magnetic column 250 and the third side wall 216 and between the induction magnetic column 250 and the cover plate 230 respectively. The supporting column 240 may be composed of a magnetic column 240a and a magnetic column 240b arranged along the first direction F. Since the arrangement in which the transformer coil group 110 is wound around the transformer magnetic column 220 in FIG. 9 is the same as the arrangement in which the transformer coil group 110 is wound around the transformer magnetic column 220 in FIG. 2, the integrated magnetic element 100 of the third embodiment can also realize the current sharing of the secondary-side coil group 114 and reduce the stresses on the secondary-side rectifier switches.

In addition, when the integrated magnetic element 100 of FIG. 8 and FIG. 9 works, the magnetic flux addition phenomenon occurs in some areas of the magnetic core structure 200, and the magnetic flux cancellation phenomenon occurs in another areas of the magnetic core structure 200. Thus, the iron loss of the integrated magnetic element 100 of FIG. 8 and FIG. 9 is greater than that of the integrated magnetic element 100 of FIG. 1 and FIG. 2.

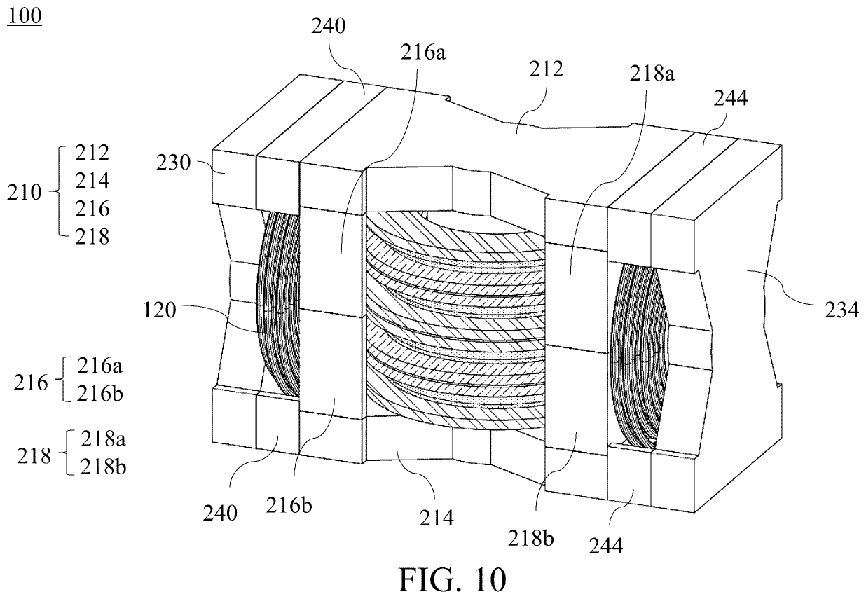

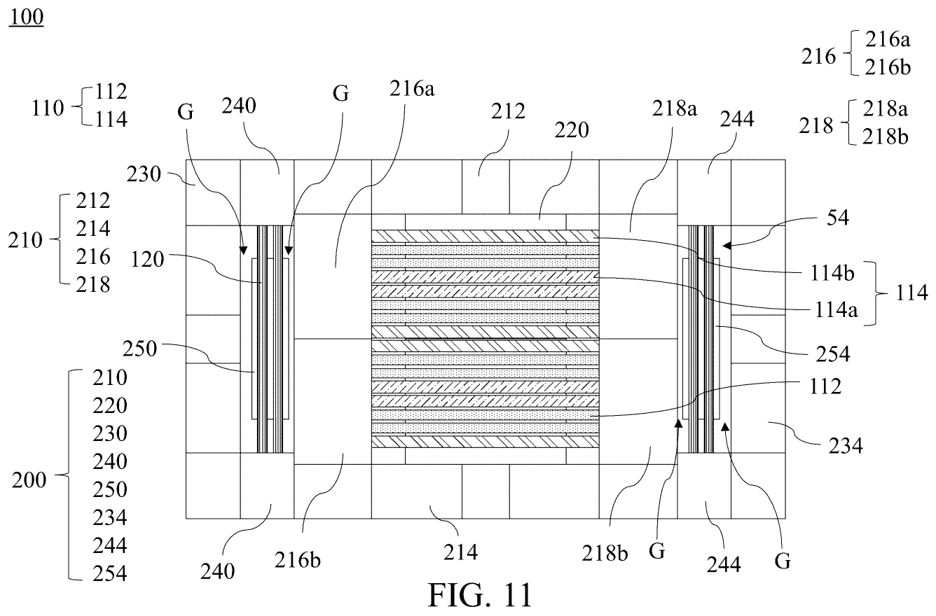

Please refer to FIG. 10 and FIG. 11, wherein FIG. 10 is a perspective view of an integrated magnetic element according to a fourth embodiment of the present disclosure, and FIG. 11 is a side view of the integrated magnetic element of FIG. 10. As shown in FIG. 10 and FIG. 11, the difference between the fourth embodiment and the third embodiment is that the magnetic core structure 200 of FIG. 10 and FIG. 11 may further comprise a cover plate 234, an induction magnetic column 254 and two supporting columns 244. The two supporting columns 244 connect the fourth side wall 218 of the magnetic frame 210 and the cover plate 234, and are disposed on opposite sides of the cover plate 234. The induction magnetic column 254 is disposed in the accommodation space 54 formed by the fourth side wall 218, the cover plate 234 and the two supporting columns 244. The central axis of the induction magnetic column 254 is perpendicular to the central axis of the transformer magnetic column 220. There may be an air gap G between the induction magnetic column 254 and the fourth side wall 218. There may be an air gap G between the magnetic column 254 and the cover plate 234. The excitation coil 120 is further wound around the induction magnetic column 254. In addition, since the arrangement in which the transformer coil group 110 is wound around the transformer magnetic column 220 in FIG. 11 is the same as the arrangement in which the transformer coil group 110 is wound around the transformer magnetic column 220 in FIG. 2, the integrated magnetic element 100 of the fourth embodiment can also realize the current sharing of the secondary-side coil group 114 and reduce the stresses on the secondary-side rectifier switches.

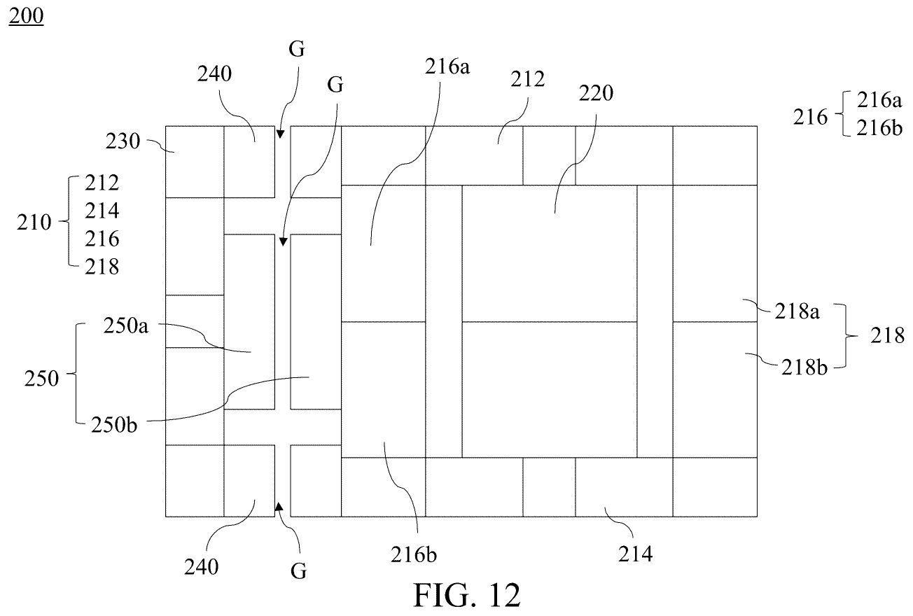

Please refer to FIG. 12, which is a side view of a magnetic core structure according to an embodiment of the present disclosure. The difference between the magnetic core structure 200 of FIG. 12 and the magnetic core structure 200 of FIG. 9 is that the induction magnetic column 250 of FIG. 12 may comprise a magnetic column 250a and a magnetic column 250b. One end of the magnetic column 250a is connected to the cover plate 230, there is an air gap G between the other end of the magnetic column 250a and one end of the magnetic column 250b, and the other end of the magnetic column 250b is connected to the third side wall 216 (that is, the induction magnetic column 250 has an air gap G), and each of the two supporting columns 240 has at least one air gap G. When the transformer coil group 110 is wound around the transformer magnetic column 220 of FIG. 12, the excitation coil 120 is wound around the induction magnetic column 250 of FIG. 12, and the excitation coil 120 is connected in parallel with the primary-side coil 112, the magnetic flux at the two supporting columns 240 is reduced due to the air gap G of the supporting column 240, which reduces the iron loss.

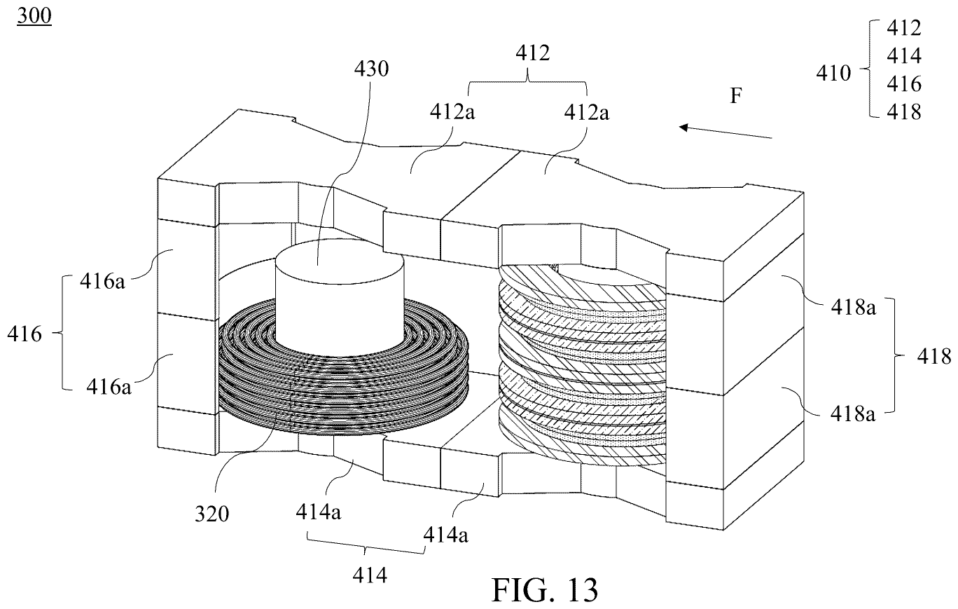

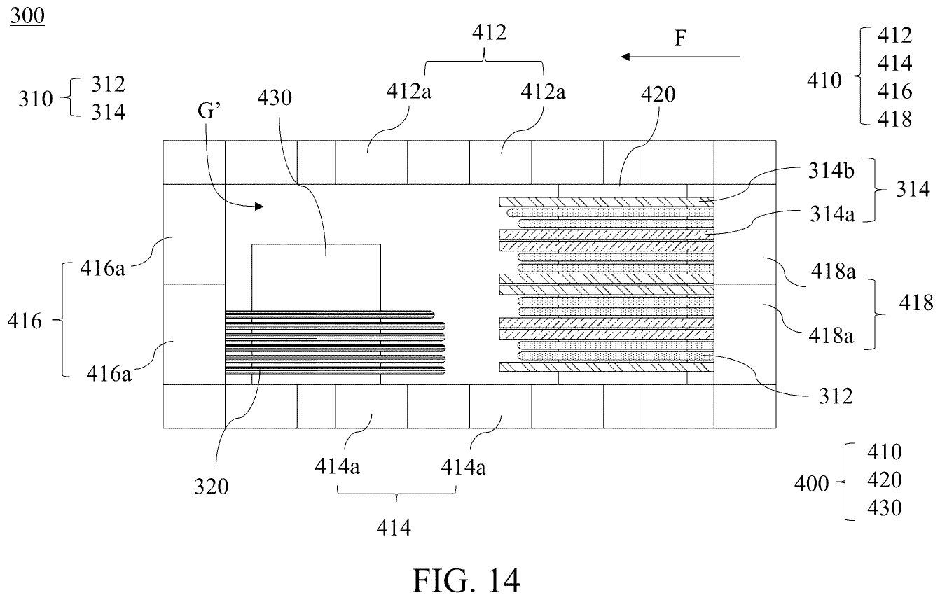

Please refer to FIG. 13 and FIG. 14, wherein FIG. 13 is a perspective view of an integrated magnetic element according to a fifth embodiment of the present disclosure, and FIG. 14 is a side view of the integrated magnetic element of FIG. 13. As shown in FIG. 13 and FIG. 14, an integrated magnetic element 300 comprises a magnetic core structure 400, a transformer coil group 310 and an excitation coil 320. The magnetic core structure 400 comprises a magnetic frame 410, a transformer magnetic column 420 and an induction magnetic column 430. The transformer magnetic column 420 is disposed in the magnetic frame 410 and connects a first side wall 412 and a second side wall 414 of the magnetic frame 410 opposite to each other. There is no air gap between the transformer magnetic column 420 and the first side wall 412, there is no air gap between the transformer magnetic column 420 and the second side wall 414, and the transformer magnetic column 420 has no air gap. The induction magnetic column 430 is connected to the second side wall 414, and there is an air gap G′ between the induction magnetic column 430 and the first side wall 412. The transformer coil group 310 is wound around the transformer magnetic column 420 and comprises a primary-side coil 312 and a secondary-side coil group 314. The excitation coil 320 is wound around the induction magnetic column 430, and the excitation coil 320 is connected in parallel with the primary-side coil 312. The winding direction of the transformer coil group 310 wound around the transformer magnetic column 420 may be opposite to the winding direction of the excitation coil 320 wound around the induction magnetic column 430 (that is, the winding directions of the windings wound around two adjacent columns are opposite to each other).

The magnetic frame 410 may comprise the first side wall 412, the second side wall 414, a third side wall 416 and a fourth side wall 418. The first side wall 412, the second side wall 414, the third side wall 416 and the fourth side wall 418 form a receiving space 62. The first side wall 412 and the second side wall 414 are arranged opposite to each other. The third side wall 416 and the fourth side walls 418 are arranged opposite to each other. The first side wall 412 may be composed of two first cover plates 412a arranged along the first direction F, the second side wall 414 may be composed of two second cover plates 414a arranged along the first direction F, the third side wall 416 may be formed by stacking two first supporting columns 416a, and the fourth side wall 418 may be formed by stacking two second supporting columns 418a. The materials of the magnetic frame 410, the transformer magnetic column 420 and the induction magnetic column 430 may be an iron powder core with low magnetic permeability, or a ferrite core with high magnetic permeability. The central axis of the induction magnetic column 430 is parallel to the central axis of the transformer magnetic column 420. However, this embodiment is not intended to limit the present disclosure.

By disposing the transformer magnetic column 420 and the induction magnetic column 430 in the magnetic frame 410, the magnetic core structure of the transformer and the magnetic core structure of the excitation inductor are integrated to achieve zero-voltage switching when the integrated magnetic element 300 is used in an LLC resonant converter, while reducing the volume to increase space utilization. In addition, the excitation inductor composed of the induction magnetic column 430 and the excitation coil 320 has an air gap G′, the transformer composed of the transformer magnetic column 420 and the transformer coil group 310 has no air gap, and the excitation coil 320 is connected in parallel with the primary-side coil 312, so that when the integrated magnetic element 300 is used in an LLC resonant converter, the copper loss of the transformer is reduced, and the drastic impact of the air gap G′ on the performance of the secondary-side coil group 314 is reduced.

In addition, the height of the integrated magnetic element 300 of the fifth embodiment is smaller than that of the integrated magnetic element 100 of the first embodiment, and the integrated magnetic element 300 of the fifth embodiment is suitable for use as a planar transformer. Besides, in FIG. 13, the overall magnetic flux density when the winding direction of the excitation coil 320 is opposite to the winding direction of the transformer coil group 310 is smaller than the overall magnetic flux density when the winding direction of the excitation coil 320 is the same as the winding direction of the transformer coil group 310.

In one embodiment, the secondary-side coil group 314 may comprise a first secondary-side coil 314a and a second secondary-side coil 314b. The transformer coil group 310 is wound around the transformer magnetic column 420 in such a periodic manner that the primary-side coil 312 is wound between the first secondary-side coil 314a and the second secondary-side coil 314b, so that the integrated magnetic element 300 realizes the current sharing of the induced currents on the secondary side, which reduces the stresses on the secondary-side rectifier switches.

In one embodiment, the primary-side coil 312 may be, but is not limited to, a coil winding and is composed of Litz wire; the secondary-side coil group 314 may be, but is not limited to, a copper sheet winding.

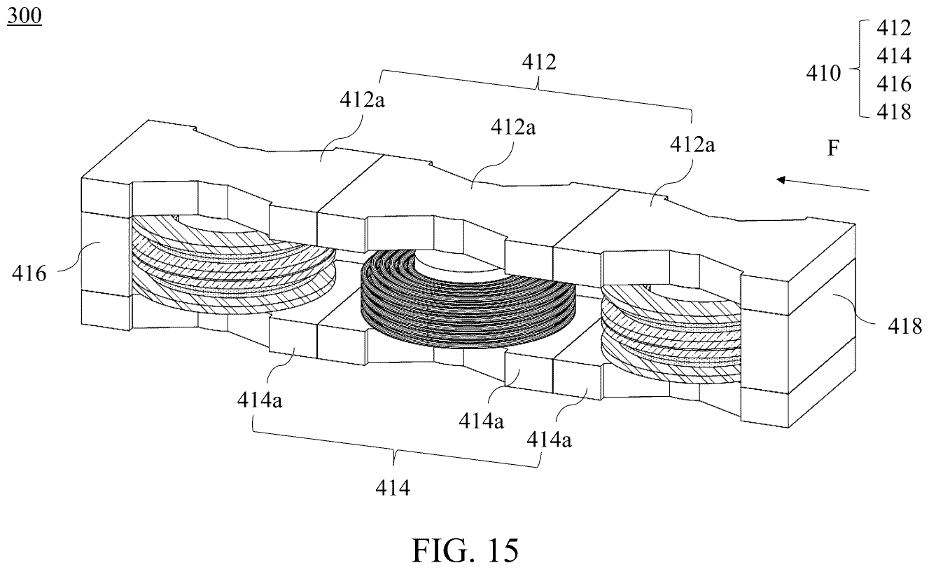

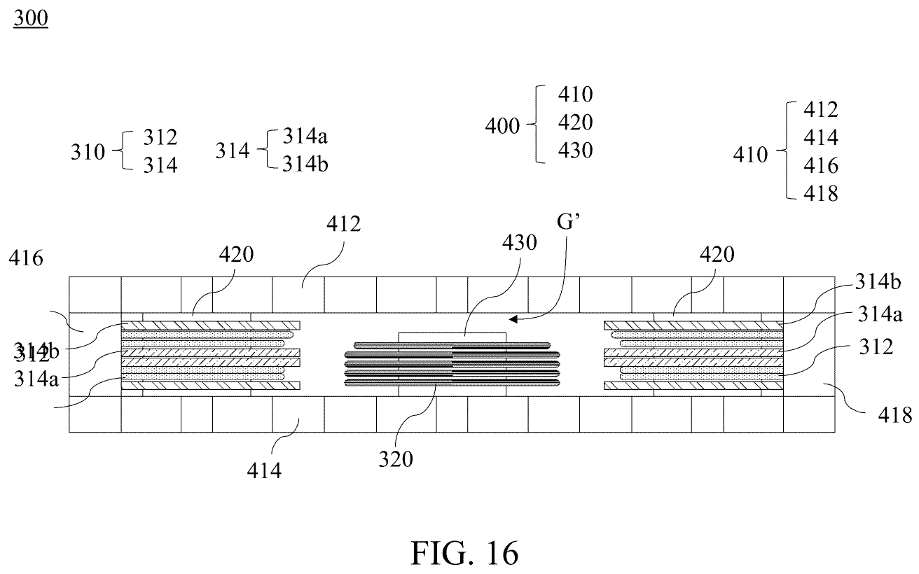

Please refer to FIG. 15 and FIG. 16, wherein FIG. 15 is a perspective view of an integrated magnetic element according to a sixth embodiment of the present disclosure, and FIG. 16 is a side view of the integrated magnetic element of FIG. 15. As shown in FIG. 15 and FIG. 16, the differences between the sixth embodiment and the fifth embodiment are that the number of transformer magnetic columns 420 is two, the number of induction magnetic columns 430 is one, the two transformer magnetic columns 420 are disposed on opposite sides of the induction magnetic column 430, and the transformer coil group 310 is wound around the two transformer magnetic columns 420. The winding direction of the transformer coil group 310 wound around the two transformer magnetic columns 420 may be opposite to the winding direction of the excitation coil 320 wound around the induction magnetic column 430 (that is, the winding directions of the windings wound around the two adjacent columns are opposite to each other). In addition, the first side wall 412 may be composed of three first cover plates 412a arranged along the first direction F, and the second side wall 414 may be composed of three second cover plates 414a arranged along the first direction F.

Besides, since the arrangement in which the transformer coil group 310 of FIG. 16 is wound around the transformer magnetic column 420 is the same as the arrangement in which the transformer coil group 310 of FIG. 14 is wound around the transformer magnetic column 420, the integrated magnetic element 300 of the sixth embodiment can also realize the current sharing of the secondary-side coil group 314 and reduce the stresses on the secondary-side rectifier switches.

The overall magnetic flux density when the winding direction of the excitation coil 320 is opposite to the winding direction of the transformer coil group 310 in FIG. 15 is smaller than the overall magnetic flux density when the winding direction of the excitation coil 320 is the same as the winding direction of the transformer coil group 310 in FIG. 15.

Since the volume of the magnetic core structure 200 of FIG. 1 is smaller than that of the magnetic core structure 400 of FIG. 15, and the size of the air gap G of FIG. 1 is smaller than that of the air gap G′ of FIG. 15, the integrated magnetic element 100 of FIG. 1 has lower iron loss and lower loss of the primary-side coil 112 than those of the integrated magnetic element 300 of FIG. 15. It should be noted that since the integrated magnetic element 100 of FIG. 1 and the integrated magnetic element 300 of FIG. 15 have different leakage inductances, different operating frequencies are required to achieve the same output voltage.

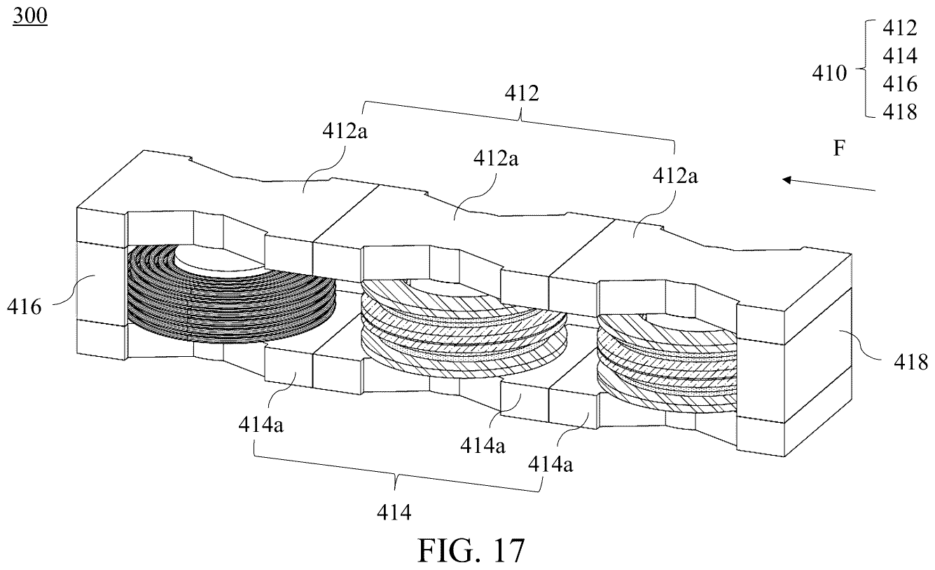

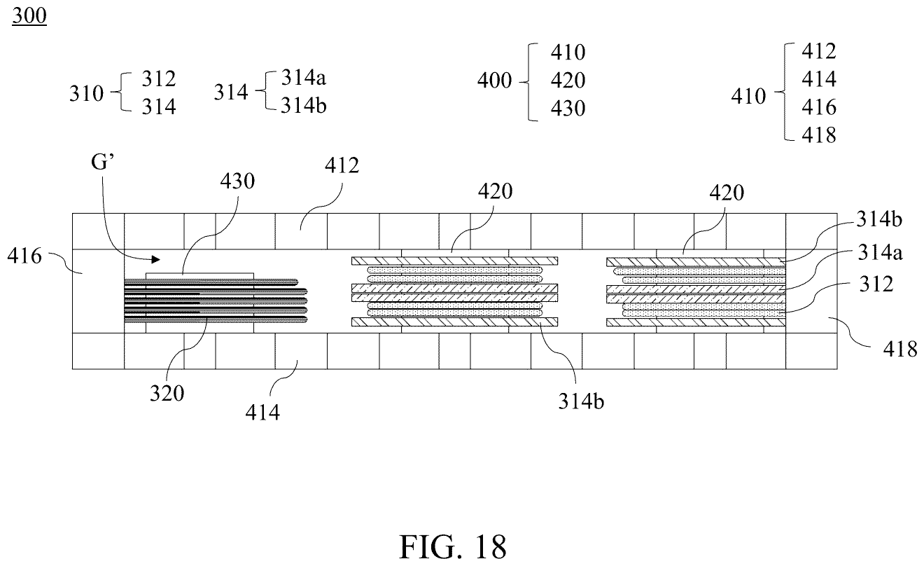

Please refer to FIG. 17 and FIG. 18, wherein FIG. 17 is a perspective view of an integrated magnetic element according to a seventh embodiment of the present disclosure, and FIG. 18 is a side view of the integrated magnetic element of FIG. 17. As shown in FIG. 17 and FIG. 18, the difference between the seventh embodiment and the sixth embodiment is that the two transformer magnetic columns 420 are disposed on one side of the induction magnetic column 430. The transformer coil group 310 is wound around two transformer magnetic columns 420 in opposite winding directions, and the excitation coil 320 is wound around the induction magnetic column 430 with the winding direction opposite to the winding direction of the transformer coil group 310 wound around the transformer magnetic column 420 adjacent to the induction magnetic column 430 (that is, the winding directions of the windings wound around the two adjacent columns are opposite to each other). In addition, since the arrangement in which the transformer coil group 310 of FIG. 18 is wound around the transformer magnetic column 420 is the same as the arrangement in which the transformer coil group 310 of FIG. 14 is wound around the transformer magnetic column 420, the integrated magnetic element 300 of the seventh embodiment can also realize the current sharing of the secondary-side coil group 314 and reduce the stresses on the secondary-side rectifier switches.

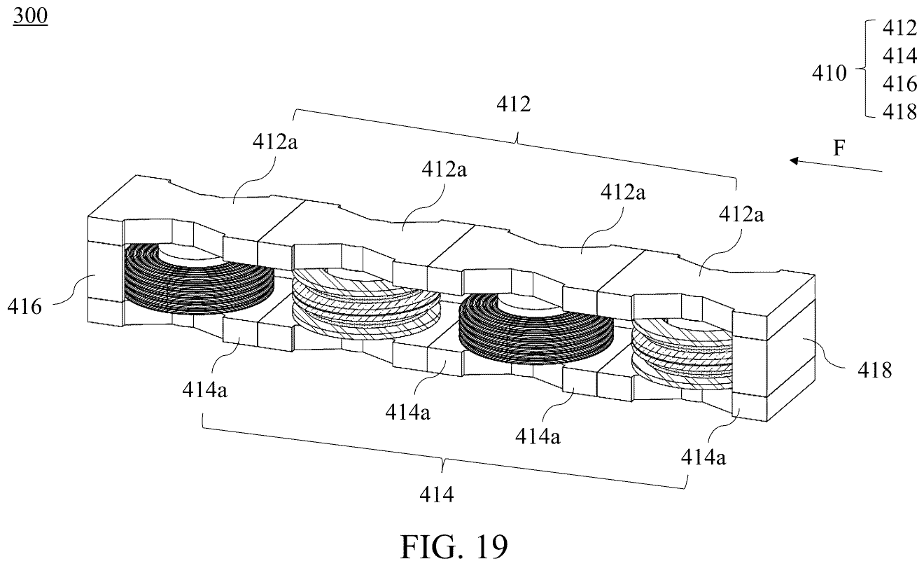

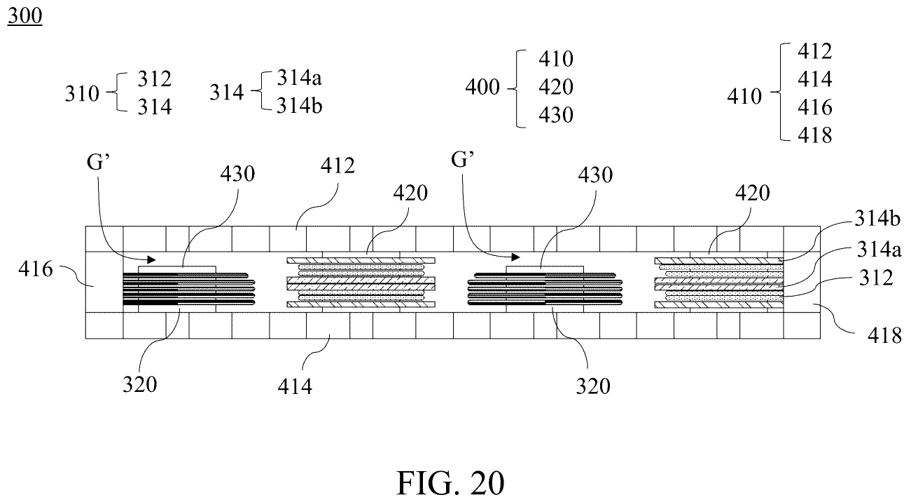

Please refer to FIG. 19 and FIG. 20, wherein FIG. 19 is a perspective view of an integrated magnetic element according to an eighth embodiment of the present disclosure, and FIG. 20 is a side view of the integrated magnetic element of FIG. 19. As shown in FIG. 19 and FIG. 20, the differences between the eighth embodiment and the fifth embodiment are that the number of transformer magnetic columns 420 is two, the number of induction magnetic columns 430 is two, the two transformer magnetic columns 420 and the two induction magnetic columns 430 are arranged alternately, the transformer coil group 310 is wound around the two transformer magnetic columns 420, and the excitation coil 320 is wound around the two induction magnetic columns 430. The transformer coil group 310 is wound around the two transformer magnetic columns 420 in the same winding direction, the excitation coil 320 is wound around the two induction magnetic columns 430 in the same winding direction, and the transformer coil group 310 is wound around the transformer magnetic column 420 with the winding direction opposite to the winding direction of the excitation coil 320 wound around the induction magnetic column 430 (that is, the winding directions of the windings wound around the two adjacent columns are opposite to each other). In addition, the first side wall 412 may be composed of four first cover plates 412a arranged along the first direction F, and the second side wall 414 may be composed of four second cover plates 414a arranged along the first direction F.

Besides, since the arrangement in which the transformer coil group 310 of FIG. 20 is wound around the transformer magnetic column 420 is the same as the arrangement in which the transformer coil group 310 of FIG. 14 is wound around the transformer magnetic column 420, the integrated magnetic element 300 of the eighth embodiment can also realize the current sharing of the secondary-side coil group 314 and reduce the stresses on the secondary-side rectifier switches.

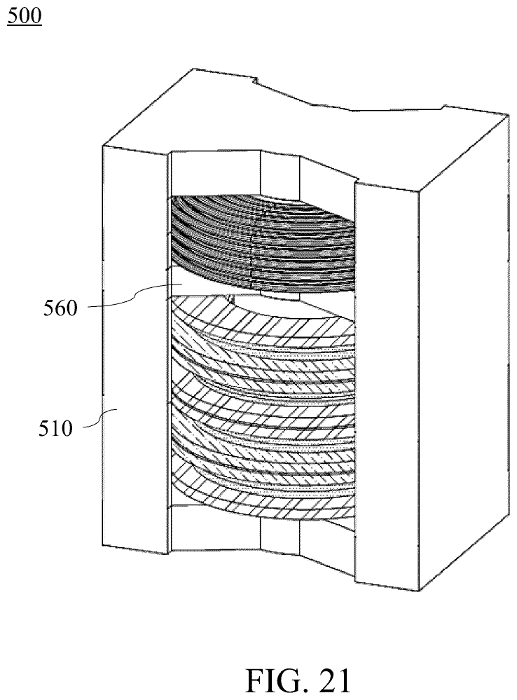

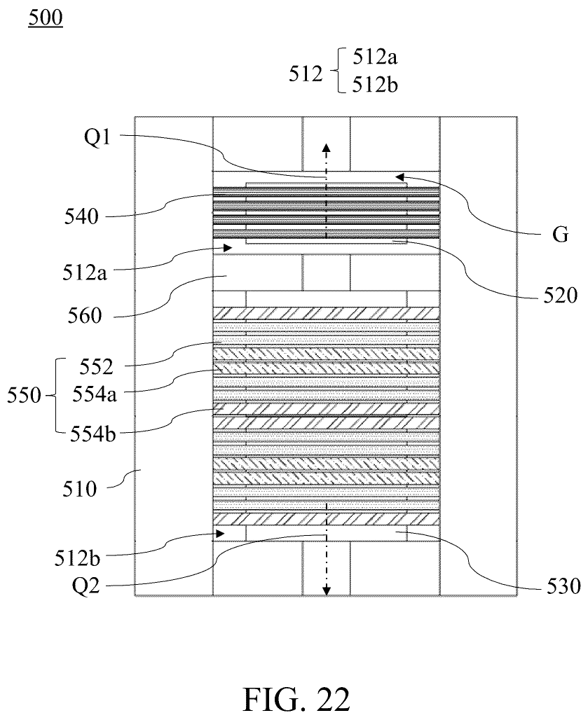

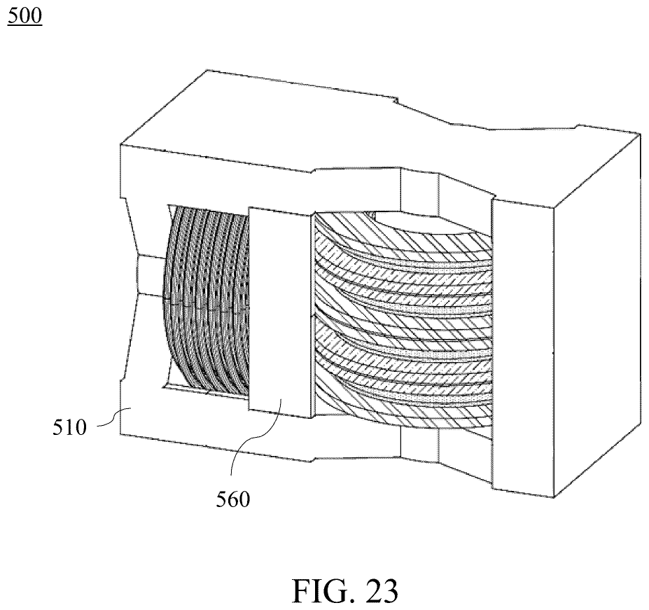

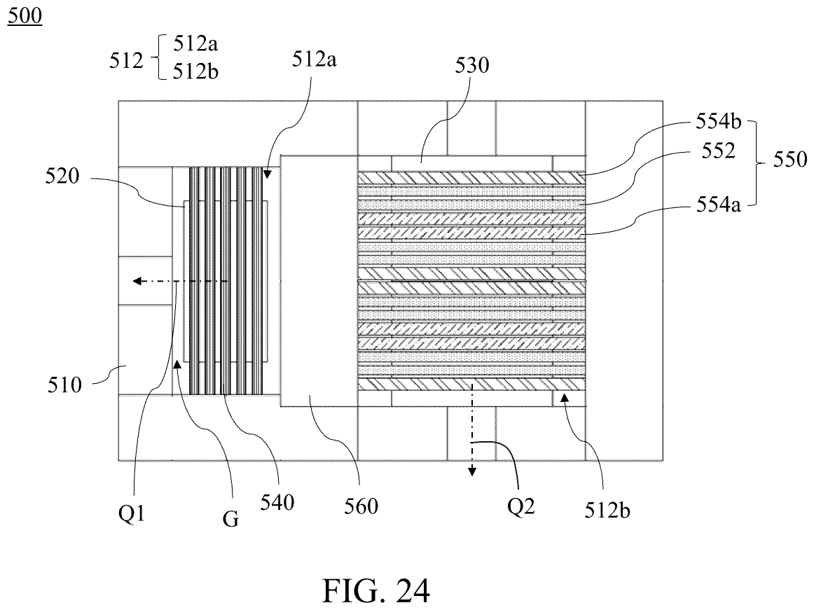

Please refer to FIG. 21 to FIG. 24, wherein FIG. 21 is a perspective view of an integrated magnetic element according to a ninth embodiment of the present disclosure, FIG. 22 is a side view of the integrated magnetic element of FIG. 21, FIG. 23 is a perspective view of an integrated magnetic element according to a tenth embodiment of the present disclosure, and FIG. 24 is a side view of the integrated magnetic element of FIG. 23. An integrated magnetic element 500 comprises a magnetic frame 510, a first magnetic column 520, a second magnetic column 530, a first winding 540 and a second winding 550. The magnetic frame 510 forms an accommodation space 512, and the first magnetic column 520 and the second magnetic column 530 are disposed in the accommodation space 512. The first magnetic column 520 has an air gap G. The first winding 540 is wound around the first magnetic column 520. The second winding 550 is wound around the second magnetic column 530. The axis extension direction Q1 of the first magnetic column 520 is the same as the axis extension direction Q2 of the second magnetic column 530 (that is, the axis extension line of the first magnetic column 520 and the axis extension line of the second magnetic column 530 are two lines that are parallel to each other, or lines that overlap each other, as shown in FIG. 22), or the axis extension direction Q1 of the first magnetic column 520 is perpendicular to the axis extension direction Q2 of the second magnetic column 530 (that is, the axis extension line of the first magnetic column 520 and the axis extension line of the second magnetic column 530 are two lines, which are perpendicular to each other, as shown in FIG. 24).

In one embodiment, the first magnetic column 520 with an air gap G means that the body of the first magnetic column 520 has the air gap G and/or there is the air gap G between the first magnetic column 520 and the magnetic frame 510. Since the closer the distance between the first winding 540 and the air gap G, the greater the loss is. Therefore, the first winding 540 does not cover the air gap G, and there is a distance between the first winding 540 and the air gap G of the first magnetic column 520; and the second magnetic column 530 has no air gap.

In one embodiment, the integrated magnetic element 500 may further comprise a spacing portion 560, and the spacing portion 560 separates the accommodation space 512 to form a first accommodation portion 512a and a second accommodation portion 512b. The first magnetic column 520 is disposed in the first accommodation portion 512a, and the second magnetic column 530 is disposed in the second accommodation portion 512b.

In one embodiment, the first winding 540 is an inductor winding, and the second winding 550 is a transformer winding. The second winding 550 may comprise a primary-side winding 552, a first secondary-side winding 554a and a second secondary-side winding 554b. The second winding 550 may be wound around the second magnetic column 530 in such a periodic manner that the primary-side winding 552 is wound between the first secondary-side winding 554a and the second secondary-side winding 554b, so that the integrated magnetic element 500 realizes the current sharing of the induced currents on the secondary side, which reduces the stresses on the secondary-side rectifier switches.

In one embodiment, the volume of the first magnetic column 520 is less than or equal to that of the second magnetic column 530.

In summary, in the integrated magnetic elements of the embodiments of the present disclosure, by integrating the magnetic core structure of the transformer with the magnetic core structure of the excitation inductor (that is, the transformer magnetic column and the induction magnetic column being disposed in the magnetic frame; or the transformer magnetic column being disposed in the magnetic frame, and the induction magnetic column being disposed in the accommodation space formed by one side wall of the magnetic frame, the cover plate and the two supporting columns; or the second magnetic column and the first magnetic column being disposed in the magnetic frame), zero-voltage switching can be achieved when the integrated magnetic element is used in the LLC resonant converter, while reducing the volume to increase space utilization. In addition, the excitation inductor has an air gap, the transformer has no air gap, and the excitation coil of the excitation inductor is connected in parallel with the primary-side coil of the transformer, so that when the integrated magnetic element is used in an LLC resonant converter, the copper loss of the transformer is reduced, and the drastic impact of the air gap on the performance of the secondary-side coil group is reduced. Besides, the transformer coil group may be wound around the transformer magnetic column in such a periodic manner that the primary-side coil is wound between the first secondary-side coil and the second secondary-side coil, so that the current sharing of the secondary-side coil group is realized, and the stresses on the secondary-side rectifier switches are reduced.

While the present disclosure is disclosed in the foregoing embodiments, it should be noted that these descriptions are not intended to limit the present disclosure. On the contrary, the present disclosure covers modifications and equivalent arrangements obvious to those skilled in the art. Therefore, the scope of the claims must be interpreted in the broadest manner to comprise all obvious modifications and equivalent arrangements.

What is claimed is:

1. An integrated magnetic element, comprising:
a magnetic core structure, comprising:
a magnetic frame;
at least one transformer magnetic column disposed in the magnetic frame, and configured to connect a first side wall and a second side wall of the magnetic frame opposite to each other, wherein there is no air gap between the first side wall and the at least one transformer magnetic column and between the second side wall and the at least one transformer magnetic column; and
at least one induction magnetic column connected to the first side wall, wherein there is an air gap between the at least one induction magnetic column and the second side wall;
a transformer coil group wound around the at least one transformer magnetic column and comprising a primary-side coil and a secondary-side coil group; and
an excitation coil wound around the at least one induction magnetic column and connected in parallel with the primary-side coil.

2. The integrated magnetic element according to claim 1, wherein the number of the at least one transformer magnetic column is two, the number of the at least one induction magnetic column is one, and the two transformer magnetic columns are disposed on opposite sides or one side of the induction magnetic column.

3. The integrated magnetic element according to claim 2, wherein when the two transformer magnetic columns are disposed on opposite sides of the induction magnetic column, a winding direction of the excitation coil is opposite to a winding direction of the transformer coil group.

4. The integrated magnetic element according to claim 1, wherein the number of the at least one transformer magnetic column is two, the number of the at least one induction magnetic column is two, and the two transformer magnetic columns and the two induction magnetic columns are arranged alternately.

5. The integrated magnetic element according to claim 1, wherein the number of the at least one transformer magnetic column is one, the number of the at least one induction magnetic column is one, and a winding direction of the excitation coil is opposite to a winding direction of the transformer coil group.

6. The integrated magnetic element according to claim 1, wherein the secondary-side coil group comprises a first secondary-side coil and a second secondary-side coil, and the transformer coil group is wound around the at least one transformer magnetic column in such a periodic manner that the primary-side coil is wound between the first secondary-side coil and the second secondary-side coil.

7. The integrated magnetic element according to claim 1, wherein the primary-side coil is a coil winding, and the secondary-side coil group is a copper sheet winding.

8. An integrated magnetic element, comprising:
a magnetic core structure, comprising:
a magnetic frame;
a transformer magnetic column disposed in the magnetic frame and connected to opposite side walls of the magnetic frame, wherein there is no air gap between the opposite side walls and the transformer magnetic column;
a cover plate;
two supporting columns configured to connect any side wall of the magnetic frame and the cover plate, and disposed on opposite sides of the cover plate; and
an induction magnetic column disposed in an accommodation space formed by the any side wall, the cover plate and the two supporting columns, wherein there is an air gap between the induction magnetic column and the any side wall, between the induction magnetic column and at least one of the two supporting columns, or between the induction magnetic column and the cover plate, or the induction magnetic column has the air gap;
a transformer coil group wound around the transformer magnetic column and comprising a primary-side coil and a secondary-side coil group; and
an excitation coil wound around the induction magnetic column and connected in parallel with the primary-side coil.

9. The integrated magnetic element according to claim 8, wherein the magnetic core structure further comprises another cover plate, another induction magnetic column and two other supporting columns; the two other supporting columns are connected to another side wall of the magnetic frame and the another cover plate, and are disposed on opposite sides of the other cover plate, and the another side wall is spaced opposite to the any side wall; the another induction magnetic column is disposed in another accommodation space formed by the another side wall, the another cover plate and the two other supporting columns, and there is another air gap between the another induction magnetic column and the another side wall, between the another induction magnetic column and at least one of the two other supporting columns or between the another induction magnetic column and the another cover plate.

10. The integrated magnetic element according to claim 8, wherein at least one of the two supporting columns has at least one air gap.

11. The integrated magnetic element according to claim 8, wherein a central axis of the induction magnetic column is parallel to a central axis of the transformer magnetic column, there is the air gap between the induction magnetic column and the any side wall and/or between the induction magnetic column and the cover plate, and the any side wall is connected to the transformer magnetic column.

12. The integrated magnetic element according to claim 11, wherein a winding direction of the excitation coil is the same as a winding direction of the transformer coil group.

13. The integrated magnetic element according to claim 8, wherein a central axis of the induction magnetic column is perpendicular to a central axis of the transformer magnetic column, there is the air gap between the induction magnetic column and at least one of the two supporting columns, and the two ends of the any side wall are connected to the opposite side walls.

14. The integrated magnetic element according to claim 8, wherein the secondary-side coil group comprises a first secondary-side coil and a second secondary-side coil, and the primary-side coil is wound between the first secondary-side coil and the second secondary-side coil.

15. The integrated magnetic element according to claim 8, wherein the primary-side coil is a coil winding, and the secondary-side coil group is a copper sheet winding.

16. An integrated magnetic element, comprising:
a magnetic frame forming an accommodation space;
a first magnetic column disposed in the accommodation space and having an air gap;
a second magnetic column disposed in the accommodation space;
a first winding wound around the first magnetic column; and
a second winding wound around the second magnetic column;
wherein an axis extension direction of the first magnetic column is the same as an axis extension direction of the second magnetic column, or the axis extension direction of the first magnetic column is perpendicular to the axis extension direction of the second magnetic column.

17. The integrated magnetic element according to claim 16, wherein there is a distance between the first winding and the air gap of the first magnetic column, and the second magnetic column has no air gap.

18. The integrated magnetic element according to claim 16, further comprising a spacing portion, wherein the spacing portion separates the accommodation space to form a first accommodation portion and a second accommodation portion, the first magnetic column is disposed in the first accommodation portion, and the second magnetic column is disposed in the second accommodation portion.

19. The integrated magnetic element according to claim 16, wherein the first winding is an inductor winding, and the second winding is a transformer winding.

20. The integrated magnetic element according to claim 16, wherein a volume of the first magnetic column is less than or equal to that of the second magnetic column.
